(19) United States
(12) Patent Application Publication
(10) Pub. No.: US 2009/0029062 A1
(43) Pub. Date: Jan. 29, 2009

(54) COIL COATING PROCESS AND APPARATUS

(75) Inventor: Kai K.O. Bar, Bad Aibling (DE)

Correspondence Address: MERCHANT & GOULD PC, P.O. BOX 2903, MINNEAPOLIS, MN, 55402-0903, US

(73) Assignee: Advanced Photonics Technologies AG, Bruckmuhl (DE)

(21) Appl. No.: 12/094,965

(22) PCT Filed: Nov. 27, 2006
(86) PCT No.: PCT/EP2006/011362

§ 371 Date: Sep. 18, 2008

(30) Foreign Application Priority Data
Nov. 25, 2005 (EP) 05025725.2

(51) Int. Cl. B05C 11/00; C08J 7/18

(52) U.S. Cl. 427/521; 118/641; 118/666

(57) ABSTRACT

A coil coating process includes thermally curing the coating of an endless strip by near infrared radiation in a curing oven provided with near infrared emitters and the subsequent destruction of volatile solvents contained in exhaust air of the curing oven by thermal oxidizing in an oxidizer chambers. Heat introduced into the solvent within the curing step is used in the oxidizing step. Air serving as coolant for the near infrared emitters is fed into the curing oven in a pre-heated state, exhausted from the curing oven loaded with the volatile solvents and guided through a heat exchanger for further heating the exhaust air by heat exchange with purified hot air exiting the oxidizer chamber, before introducing the exhaust air into the oxidizer chamber

The invention relates to a coil coating process according to the preamble of claim 1, as well as to a coil coating apparatus which is suitable for such coil coating process.

Within the last decades enormous developments of coil coatings have been achieved, but still today the appropriate coatings consist significantly of, mostly flammable, solvents. Even in water based systems which meanwhile have reached commercialization, their co-solvents (5% up to 20% of total liquid content) require proper solvent treatment, mostly by thermal destruction of the VOCs (versatile organic components).

For today's given solvent loads in the coatings, in most coil coating processes therefore an usage of this intrinsic (“free of charge”) heat is undertaken, preferred in combined operation of the curing apparatus (gas convection ovens) and the thermal solvent treatment systems (thermal oxidizers, TO). Since the required curing oven power is mainly driven by the coil production rate and the proper curing requested PMT, the thermal oxidizer or incinerator, respectively, is designed to guarantee the destruction of the ultimate possible solvent load in he coil coating process. So the higher the solvent load in the extraction air flow rate, the lower the required fuel consumption for the thermal VOC destruction process in the TO. At high caloric solvent contents low additional fuel consumption can be reached during an ongoing coating process.

But even with highly optimized combined oven/TO configurations, this can be achieved with today's
solvent types and concentrations
applied coating thicknesses and
max. allowed LEL operation scenarios
   only for ultimate (best-case design values) working conditions.

Reflecting typically required day-by-day production scenarios, due to required
variations in coated coil width
variations in coil thickness and
production speeds,
   a high fuel consumption is necessary, to run this combined process.

Therefore, energy operation costs are significant cost components in a coil coating process. They become even higher if an alternative potential coating does contain less solvents. An ecologically driven optimization (less solvents or even fully water based composition) can herewith never compete with the economically driven coating business.

According to these circumstances, it is common understanding that all other curing oven configurations than gas convection ovens, which are all electrical “fired”, will have even higher energy operation costs.

Besides gas convection ovens, electrically or gas powered infrared or electrically powered induction heating thermal curing technologies, a near infrared radiation based technology has recently been developed and is on strong advance to becoming established as the standard curing technology in coil coating processes.

The near infrared technology allows, due to the extraordinary wave length spectrum (near infrared), extremely high available emitting heat intensity and the special systems engineering, for an ultra fast drying and curing of coatings. So today's commercially available coil coatings, which require 8-10 s with conventional induction curing systems, 12-15 s with infrared systems or even 20-25 s with gas convection ovens, can be dried and cured in 1-3 s, even up to dry film thicknesses of more than 20 μm.

For evaporating solvents resulting from the drying/curing process of coatings, two major thermal solutions for destruction VOC's in the exhaust air are:
thermal (recuperative) Oxidizer (TO)
regenerative thermal Oxidizer (RTO)

The basic working principle of the TO is as follows:

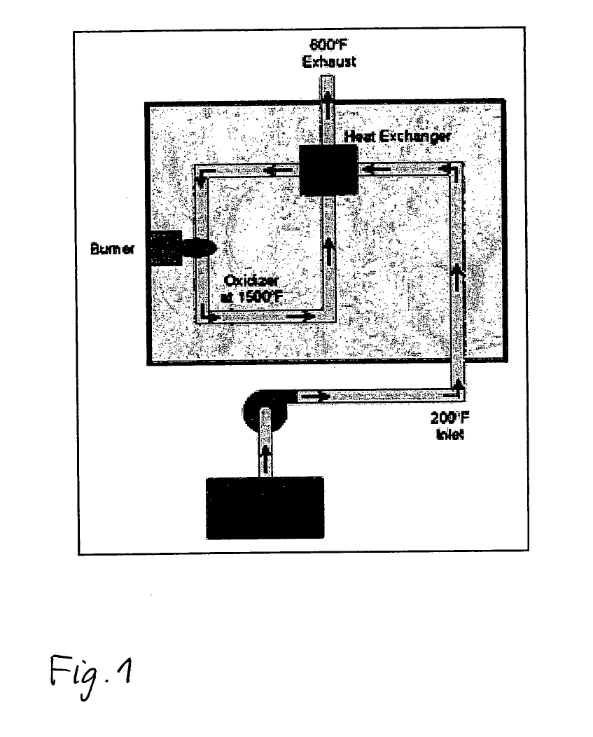

Solvent loaded exhaust air which carries the evaporated solvents out of the curing oven will be fed in a combustion chamber, where it is burnt by gas burners at temperatures of ≧750° C. to ensure VOC destruction. Depending on the specific system configuration an implemented intermediate preheat exchanger (recuperation) allows for higher thermal efficiency. A TO-process is schematically shown in FIG. 1.

A regenerative thermal oxidizer process is as follows:

The solvent containing exhaust air flow is fed to a ceramic based heat exchanger bed which further heats up the incoming air flow before it is reaching the combustion chamber. The clean gas flow is also fed through the exchanger which provides the heat to heat up the ceramic bed. The finally resulting clean gas outlet temperature is only ≈40-50 K higher than the exhaust inlet temperature.

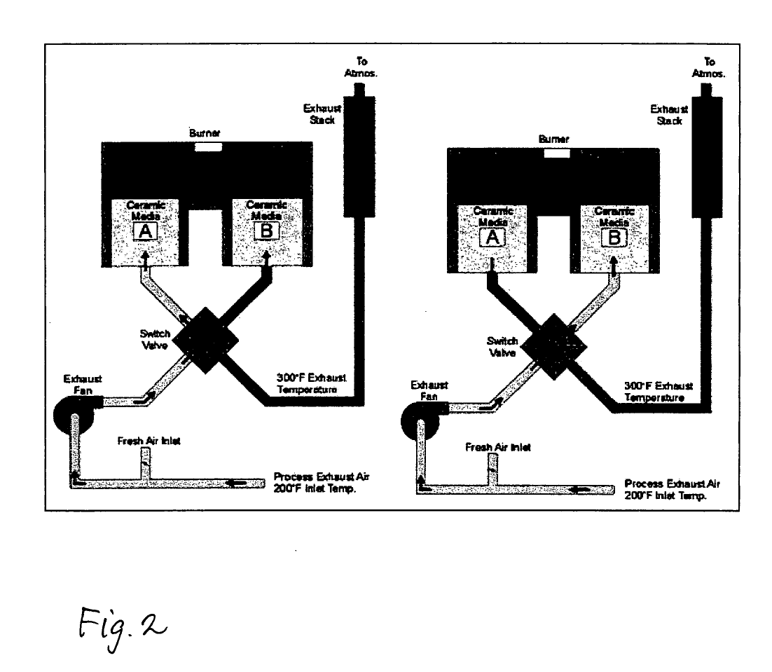

Already at very low solvent load (≧1.5 g/Nm³ air) an autotherm oxidation of the exhaust flow can be obtained. A sketch of the RTO working principle is shown in FIG. 2.

For today's applied solvents, it has also be reflected that due to the high boiling temperature the risk of solvent condensation is given along the solvent evaporation and air exhaust ducting, if not sufficiently thermally processed.

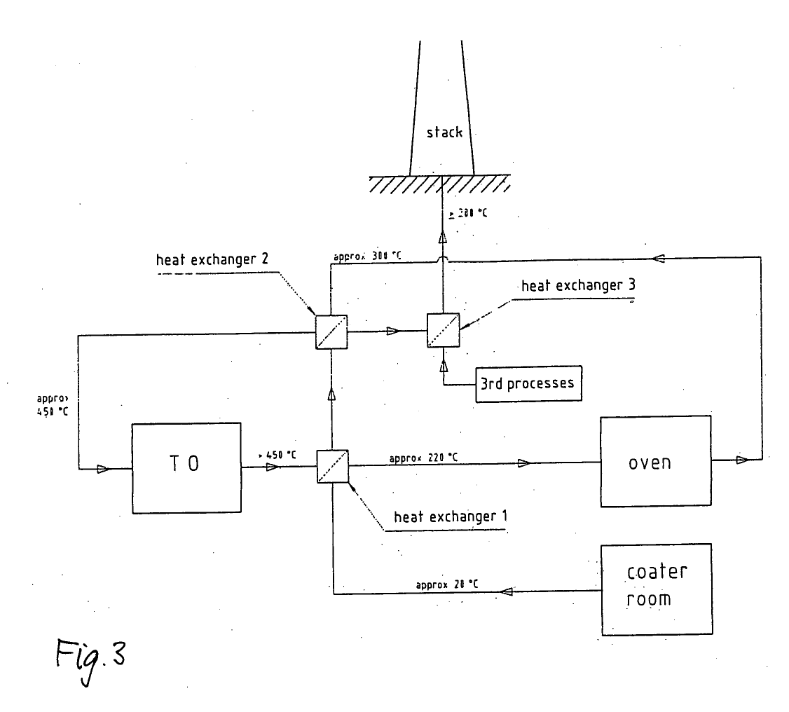

To illustrate an optimized solution, a combination of a gas convection oven with a thermal oxidizer, is shown in FIG. 3.

The recovery heat of the high temperature clean gas can be used to power (at least partially) the gas convection oven in a second heat exchanged thermal process. The required gas consumption for this combined curing oven and TO process is depending on the given solvent load and caloric heat of the solvent types.

It is an object of the invention to provide for an improved coil coating process which, in particular, ensures an improved energy efficiency and in so far improved competitiveness of ecologically favourable coatings. Furthermore, it is an object of the invention to provide for a correspondingly improved coil coating apparatus.

These objects are solved by coil coating process according to claim 1 on one hand and a coil coating apparatus according to claim 6 on the other.

Preferred embodiments and aspects of the invention may be derived from the dependent claims or the following description:

For extraction of the evaporating solvents from inside the curing oven, the required air flow for internal cooling purposes is dimensioned to achieve preheated air up to approx. 150-160° C. before it is entering the internal process chamber. Due to the given process chamber design, the complete internal wall arrangement is heated up immediately when operating the oven, so while the system is running, internal wall temperatures between 180-230° C. are given. Thus, inside the curing system no solvent condensation can occur, due to the elevated internal process chamber temperature.

The exhaust solvent loaded air flow with a temperature of 150-180° C. before entering the entry section of the RTO is fed through a heated duct, which is preheated from the outside by the exit clean gas air flow coming from the RTO (temperature of 200-230° C.) before it is leaving through the stack to the ambient.

With this system arrangement, no additional preheating of the solvent exhaust air is required. On the other hand, sufficient precautions are implemented to avoid any condensation risks in all operation scenarios. Since already at solvent contents above 1.5 g/Nm³ of exhaust air autotherm oxidation (solvent destruction treatment) can be achieved; at higher solvent loads even significant heat excess can be earned, for potential 3^{rd} required heating processes.

Furthermore, the required water cooling infrastructure is designed and dimensioned to provide 70-80° C. hot water, which can also be used for 3^{rd} thermal processes (e.g. preheating chemical cleaning bathes).

So, based on this process configuration, an extremely energy optimized drying/curing process in combination with the required thermal solvent treatment is obtained.

Furthermore, major advantages of the proposed new system are as follows:

With the present invention, since no recovery of heat excess of solvent treatment for the curing oven is necessary, the use of an RTO process becomes significantly more efficient (due to higher system's efficiency ≧95% instead of ≦65% for TOs and the intrinsic extremely low clean gas temperature level) and therefore an autotherm solvent treatment can be achieved at solvent loads of as low as 3% (LEL).

A wide range air flow adjustment capability for controlled high LEL operation can be realized to minimize energy requirements for solvent treatment.

Full transient operation capability to follow the demanding actual production scenario—without any lead strip or reduced production speed limitations—may be achieved.

Resulting from this, a typical overall energy operation request of ≦50 kWh per metric ton organic coated strip are realistically achieved in day by day operation, which has to be provided as electrical power. But no additional gas consumption for the thermal solvent treatment has to be considered. And significant recovery heat excess for third processes (80° C. hot water as well as hot air at 850° C.) which can even be up to more than ≧50 kWh/t can be achieved with the new process.

Finally it has to be reflected, that due to the lower required PMT for the curing process a significantly lower cooling request (15-25%) for the strip cooling will even further improve the excellent energy balance which can be achieved with the new process.

Below the invention is described in more detail, referring to the figures.

FIG. 1 schematically illustrates the working principle of a TO process.

FIG. 2 schematically illustrates the working principle of an RTO process.

FIG. 3 illustrates a process scheme of an optimized combined curing and TO process.

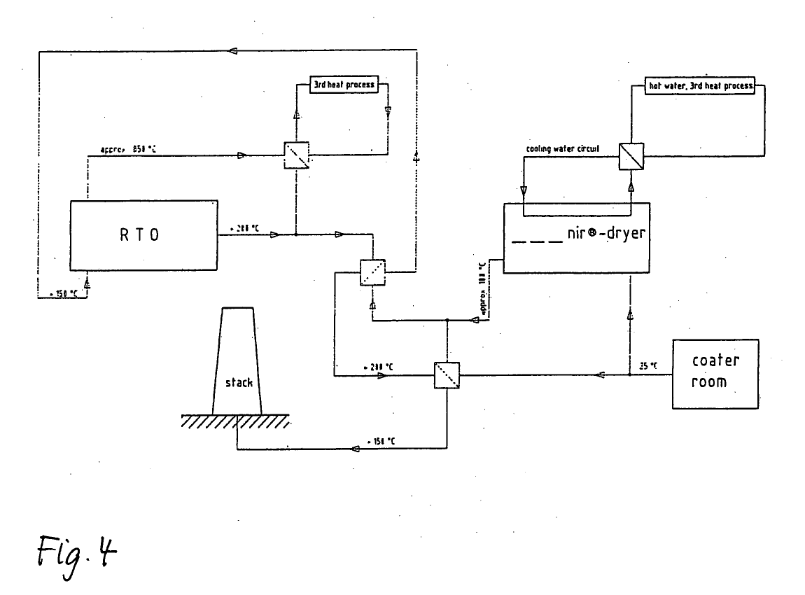

FIG. 4 schematically illustrates the process scheme of a preferred embodiment of the invention.

Table 1 presents line and process data of a typical coil coating line/process.

Table 2 presents a comparative listing of major oven and thermal incineration systems data of a conventional process and an embodiment of the new process.

FIGS. 3 and 4 are, in the light of the above general explanation, basically self-explaining. Therefore, no further detailed description of the components of the apparatus' and process flow need to be given here.

In Table 2 the major line and process data have been summarized. In Table 3 the major oven and incineration systems data are compiled.

For the given case, the total required energy consumption of conventional solution for the max. given solvent load and the max. given production capacity is 2.300 kW (gas consumption+air ventilation blower power) even taking 1.210 kW of solvent content into account. Additionally the purified exhaust gas (16.200 Nm³/h at 400° C.) could be used for 3^{rd} thermal process, before leaving through the stack.

For this scenario, the new process requires 890 kW electrical energy (total energy for near infrared oven operation, including cooling and air ventilation power requirements). The RTO system is operating in autotherm conditions, and 960 kW recovery heat of given heat excess is possible (approx. 1.5 t/h steam generation). So at best case conditions for the conventional system solution approx. 2.58 times more energy is required. When including the air blowers into the calculation, this values becomes even higher.

So at max. operation conditions, only at a gas price which are more than 2.6 times lower than electricity, the energy operation costs of the new process are higher. When evaluating the min. coating case with only 39 kg/h solvent load an a production capacity of 8.5 t/h for the conventional process 2.360 kW (gas consumption) are required (while 360 kW as intrinsic solvent heat capacity is give here). For the new process 450 kW electrical power is required and still a recovery heat of 280 kW for approx. 0.45 t/hr steam generation is possible. Here the request of energy for the conventional process is about 5.2 times higher.

When assuming standby the required power for the conventional process is even increasing to 2.720 kW (full gas consumption) to keep the curing oven as well as the TO ready to operate.

For the new process there is usually no need for standby operation conditions. In cases of shut down (e.g. emergency stop or for cleaning/maintenance purposes on the line) the generation near infrared radiation is stopped, and for standby of more than 20 min. the RTO has to be heated with a gas burner to keep it ready to operate. The required energy consumption herefore is 100 kW.

TABLE 1

| Max production capacity: | 17.7 t/h | |
|---|---|---|
| Reference coil | 0.40 mm × 1,250 mm × | |
| | 75 m/min | |
| Max. production speed | 75 m/min | |
| Thickness variations | 0.25-0.4 mm | |
| Width variations | 1,090 mm-1,250 mm | |
| Finish coatings: | Average: | TS: 20 μm |
| | | BS: 10 μm |
| Solvent content: | Average: | 50% |

| | |
|---|---|
| Solvent caloric Value | 33,500 KJ/kg |
| Max. allowed LEL | 20% (8 g/Nm³) |
| max solvent content (Design Value): | 130 kg/h |
| Required airflow rate(to stay below 20%) | 16,200 Nm³/h |
| Min. solvent load: | 39 kg |
| Equivalent min. required airflow rate: | 4,900 Nm³/h |

Operation scenario:

| | |
|---|---|
| Net production time | 5,200 h |
| Standby, start up, leadstrip operation: | 1,800 h |
| | 7,000 h |

TABLE 2

| | Combination gas | SYNERGY- |
|---|---|---|
| | convection | HEAT- |
| Reference coil | system/TO | Process |
| at | | |
| Air inlet temperature oven | 280° C. | 160° C. |
| Air outlet temperature | 227° C. | 170° C. |
| Gas/electrical power | 1,090 kW/780 kW | 890 kW |
| consumption | | |
| Air inlet temperature at TO (after | 400° C. | 180° C. |
| preheating) or RTO | | |
| Air outlet temperature at TO/RTO | 760° C. | 220° C. |
| VOC destruction temperature | 760° C. | 850° C. |
| TO/RTO) | | |
| By pass temperature at RTO | | 850° C. |
| Additional Gas consumption at | >1,230 kW | 0 |
| may. Load TO/RTO | | |
| Additional Gas consumption at | 1,560 kW | 0 |
| min. solvent load TO/RTO | | |
| Additional Gas consumption | 1,920 kW | 100 kW |
| during standby TO/RTO | | |

1. Coil coating process, comprising:
thermally curing the coating of an endless strip by near infrared radiation in a curing oven provided with near infrared emitters;
subsequently destroying volatile solvents contained in exhaust air of the curing oven by thermal oxidizing the volatile solvents in an oxidizer chamber,
wherein heat introduced into the solvent within the curing step is used in the oxidizing step, wherein air serving as coolant for the near infrared emitters is fed into the curing oven in a pre-heated state, exhausted from the curing oven loaded with the volatile solvents and guided through a heat exchanger for further heating the exhaust air by means of heat exchange with purified hot air exiting the oxidizer chamber, before introducing the exhaust air into the oxidizer chamber.

2. Coil coating process according to claim 1, wherein the radiation and air flow system of the curing oven are adapted to maintain an air temperature of approximately 130-180° C. upon entry into the curing oven whereas the oven wall temperatures are above 180° C., to avoid volatile solvent condensation at the walls.

3. Coil coating process according to claim 1, wherein water cooling of the curing oven is provided such that at a cooling system outlet hot water of approximately 60-90° C. is provided.

4. Coil coating process according to claim 1, wherein the heat exchange step is adapted to result in an outlet air temperature of the heat exchanger of 170-210° C.

5. Coil coating process according to claim 1, wherein the oxidizer chamber is gas-fuelled and heating means thereof are controlled in response to a measurement of the outlet air temperature of the heat exchanger.

6. Coil coating apparatus, comprising:
a curing oven provided with near infrared emitters for curing a coating of an endless strip,
an oxidizer chamber for thermally destroying volatile solvents originating from the coating and exhausted from the curing oven, and
a heat exchanger provided between the curing oven and the oxidizer chamber for increasing the exhaust air temperature of the curing oven by a heat exchange with purified air exiting the oxidizer chamber, wherein the curing oven is provided with an air cooling system adapted such that input air first cools the near infrared emitters and is fed into the curing oven thereafter as pre-heated transport gas for volatile solvents to transport the volatile solvents to the oxidizer chamber via the heat exchanger.

7. Coil coating apparatus according to claim 6, wherein the oxidizer chamber comprises gas-fuelled heating means and a control unit for controlling the heating means in response to a temperature signal derived from a temperature detection unit at an outlet of the heat exchanger.

8. Coil coating apparatus according to claim 6, wherein the radiation and air flow system of the curing oven are adapted to maintain an air temperature of approximately 130-180° C. upon entry into the curing oven whereas the oven wall temperatures are above 180° C., to avoid volatile solvent condensation at the walls.

9. Coil coating apparatus according to claim 6, wherein a water cooling system of the curing oven is provided such that at a cooling system outlet hot water approximately 60-90° C. is provided.

10. Coil coating process according to claim 1, wherein the radiation and air flow system of the curing oven are adapted to maintain an air temperature of approximately 150-160° C. upon entry into the curing oven whereas the oven wall temperatures are above 180° C., to avoid volatile solvent condensation at the walls.

11. Coil coating process according to claim 1, wherein water cooling of the infrared emitters is provided such that at a cooling system outlet hot water of approximately 60-90° C. is provided.

12. Coil coating process according to claim 1, wherein water cooling of the near infrared emitters, is provided such that at a cooling system outlet hot water of approximately 70-80° C. is provided.

13. Coil coating process according to claim 1, wherein water cooling of the curing oven, is provided such that at a cooling system outlet hot water of approximately 70-80° C. is provided.

14. Coil coating process according to claim 1, wherein the heat exchange step is adapted to result in an outlet air temperature of the heat exchanger of 180-190° C.

15. Coil coating apparatus according to claim 6, wherein the radiation and air flow system of the curing oven are adapted to maintain an air temperature of approximately 150-160° C., upon entry into the curing oven whereas the oven wall temperatures are above 180° C., to avoid volatile solvent condensation at the walls.

16. Coil coating apparatus according to claim 6, wherein a water cooling system of the infrared emitters, is provided such that at a cooling system outlet hot water approximately 60-90° C. is provided.

17. Coil coating apparatus according to claim 6, wherein a water cooling system of the infrared emitters is provided such that at a cooling system outlet hot water approximately 70-80° C. is provided.

18. Coil coating apparatus according to claim 6, wherein a water cooling system of the curing oven, is provided such that at a cooling system outlet hot water approximately 70-80° C. is provided.
